(19) United States
(12) Patent Application Publication
(10) Pub. No.: US 2026/0340462 A1
(43) Pub. Date: Oct. 29, 2026

(54) Optimizing Distributed Computer Networks using Quantum Gradient Descent Network Landscape Navigation

(71) Applicant: Bank of America Corporation, Charlotte, NC (US)

(72) Inventors: Pratheesh Venkatraman, Concord, NC (US); Pushkar Taneja, Hyderabad, Telangana (IN); Dnyanesh P. Ballikar, St. Johns, FL (US); Yash Dashputra, Hyderabad, Telangana (IN); Amar Deep Reddy, Hyderabad, Telangana (IN); Rahul Saluja, Hyderabad, Telangana (IN); Lisa Brown, Charlotte, NC (US)

(21) Appl. No.: 19/061,806

(22) Filed: Feb. 24, 2025

(51) Int. Cl. G06N 10/20; G06N 10/60

(52) U.S. Cl. CPC G06N 10/20; G06N 10/60

(57) ABSTRACT

Quantum entangled domain map analysis and quantum gradient descent network landscape analysis are designed to enhance inter-domain connectivity and decision-making efficiency across distributed computer networks. Quantum entangled domain map analysis uses quantum entanglement principles to create a comprehensive mapping of network domain features to identify connectivity gaps between domains and to adaptively provide cross-domain optimizations to the network. Quantum gradient descent network landscape analysis utilizes quantum gradient descent methods to intelligently navigate the optimization landscape of inter-domain relationships in the distributed network. By minimizing cost functions associated with network connectivity, quantum gradient descent network landscape analysis reduces computation time significantly while enhancing the accuracy of determining the most effective pathways for data flow.

### TECHNICAL FIELD

The technical field generally pertains to applying quantum computing and machine learning techniques to managing and diagnosing issues in a complex distributed network system. Specifically, quantum entangled domain mapping or quantum gradient descent algorithms are combined with federated machine learning across multiple network nodes to improve data quality and connectivity across domains.

### BACKGROUND

In today's complex distributed networking systems, machine problems can arise due to various factors, including hardware failures, software bugs, and environmental conditions. To effectively diagnose and resolve these issues, it is essential to leverage multiple sources of information that can provide valuable insights into the problem. However, current approaches in unsupervised machine learning often focus on a single source of information, such as sensor data or network logs, which can lead to incomplete and inaccurate diagnoses.

One critical challenge stems from the large scale at which modern AI systems operate. AI models are increasingly built on massive datasets, often collected from numerous distributed sources. Privacy and security concerns arise when attempting to utilize datasets from multiple sources with different trust levels or security requirements. The challenge lies in combining these various sources of information in a way that effectively captures the complexities of the system and enables more accurate and informed decision-making while preserving the privacy and security of the information.

Challenges related to data quality are also particularly significant in AI environments that rely on vast amounts of data for training and decision-making. Poor-quality data, whether due to inconsistencies, missing information, or errors during data collection, can lead to substantial inaccuracies in the output generated by AI models. When data is not thoroughly validated before being fed into AI systems, the resulting models may produce flawed insights, decisions, or recommendations. Inadequate data validation and cleansing mechanisms exacerbate the problem, leading to a ripple effect where minor errors compound as data moves through multiple layers of AI processing, further degrading model accuracy.

Federated learning environments, in which data is gathered from decentralized systems and processed collaboratively, introduce additional layers of complexity in maintaining data integrity. In such environments, data from a single compromised source can infiltrate and degrade the system's accuracy. The decentralized nature of federated learning complicates detecting anomalies and correcting data, as data discrepancies may be hidden within specific segments or silos, making them difficult to detect until they have propagated through the system.

The unmet need is clear for a more sophisticated approach for distributed networking components that can seamlessly integrate and fuse diverse sources of information and enable network operators to quickly identify and resolve issues, reducing downtime and improving overall system performance. This need is especially critical as networks become larger with more variation in the capabilities and security of distributed nodes within the network.

### SUMMARY OF THE INVENTION

Aspects of the disclosure provide effective, efficient, scalable, and convenient technical solutions that address and overcome the technical issues associated with distributed networking components that integrate and fuse diverse sources of information and enable network operators to quickly identify and resolve problems, reducing downtime and improving overall system performance.

Various aspects employ a novel Source Domain Layer (SDL) system, a Quantum Federated Learning Layer (QFL) system, a Quantum Entangled Domain Mapper (QEDM), and/or a Quantum Gradient Descent Landscape Navigator (QGDLN) that identify network gaps and optimize inter-connectivity for enhanced decision-making efficiency across distributed networks.

The SDL ensures the quality and consistency of data collected from various nodes within a distributed network. The SDL includes comprehensive node data collection and meticulous data preprocessing to handle inconsistencies and enhance data quality. By standardizing the input from each node, The SDL enables more reliable processing by the QFL system and subsequently by the QEDM and/or QGDLN systems.

The QFL system represents a significant leap forward by combining quantum computing with federated learning principles. In this layer, multiple parties can collaboratively train a machine learning model while retaining their raw data, thus maintaining privacy and security. Applying quantum bits (qubits) dramatically improves computational efficiency, resulting in faster training times and enhanced model performance. This synergistic melding of quantum computing and machine learning provided by the QFL system allows for expansive knowledge generation arising from distributed nodes' collective intelligence. The QFL system allows for real-time updates and fine-tuning of models based on collective network data, drastically improving model accuracy and learning convergence. In this context, the blended use of quantum computing techniques introduces a new level of flexibility and responsiveness that traditional federated learning lacks.

The QEDM and QCDLN systems integrate quantum technologies with advanced data processing and machine learning techniques, transforming how data is managed and utilized across multiple domains. The QEDM system leverages quantum entanglement principles to create a comprehensive mapping of domain features, identifying connectivity gaps and fostering adaptive cross-domain strategies. The QGDLN system utilizes quantum gradient descent processes to intelligently navigate the optimization landscape of inter-domain relationships to identify connectivity gaps. By minimizing cost functions associated with network connectivity, QGDLN reduces computation time significantly while enhancing the accuracy of determining the most effective pathways for data flow, ultimately leading to optimized decision-making processes.

Individually or together, these components provide a deeper understanding of inter-domain relationships-a novel contribution to the field- and empower adaptive, real-time decision-making across complex networks. Through AI-predictive analytics and collaborative decision algorithms, the described systems are transformative over prior art systems in how multifaceted data is interpreted and acted upon to create more intelligent and resilient decision systems.

Combining QEDM and QGDLN creates a unique framework for federated learning that prioritizes user privacy while maximizing collaborative intelligence. By mapping domain features with QEDM and applying quantum descent for optimization in QGDLN, nodes can share insights about inter-domain relationships without exposure to individual data, thus maintaining confidentiality in a distributed network scenario. Combining QEDM and QGDLN also lays the foundation for intelligent decision systems capable of navigating complex multi-domain interactions. By utilizing quantum-derived insights, these systems can generate automated recommendations that adapt to emerging conditions and network changes, empowering organizations to make informed strategic decisions that leverage collective knowledge and real-time data integration-revolutionizing the approach to network dynamics and collaborative governance.

In light of the foregoing, the following provides a simplified summary of the present disclosure to offer a basic understanding of its various parts. This summary is not exhaustive nor limits the exemplary aspects of the inventions described herein. It is not designed to identify the disclosure's key or critical elements or steps or define its scope. Instead, as understood by a person of ordinary skill in the art, it is intended to introduce some concepts of the disclosure in a simplified form as a precursor to the more detailed description that follows. The specification throughout this application contains sufficient written descriptions of the inventions, including exemplary, non-exhaustive, and non-limiting processes and processes for making and using the inventions. These descriptions are presented in full, clear, concise, and exact terms to enable skilled artisans to make and use the inventions without undue experimentation, and they delineate the best mode contemplated for carrying out the inventions.

An example embodiment that incorporates quantum entanglement domain mapping may include a quantum-based system for detecting and optimizing inter-domain gaps in a distributed network, wherein the quantum-based system comprises a plurality of subsystems implemented with at least one classical computer, at least one quantum computer, and at least one memory that stores computer-executable instructions. The quantum computer may use superconducting materials, photonics, neutral atoms, trapped ions, quantum dots, helium electrons, or nitrogen-vacancy diamonds to implement quantum bits representing the quantum states. The plurality of subsystems may include a source domain system, a quantum federated learning system, a quantum entanglement domain mapper (QEDM) system, and a decision determination system. When executed by the at least one classical computer and the at least one quantum computer, the computer-executable instructions may cause the subsystems to perform certain functions.

For example, the source domain system may identify data in real-time from a plurality of domains in the distributed network and extract, from the data, a plurality of feature sets that characterize the plurality of domains, respectively. The domains may comprise different hardware linked by network connections. Each of the plurality of domains may have multiple processes performed therein, wherein the multiple processes in one of the plurality of domains have performance metrics that have interdependencies with performance metrics of the multi processes in another one of the plurality of domains. The performance metrics may include bandwidth usage, latency, or error rates. The quantum federated learning system may encode the plurality of feature sets respectively to a plurality of quantum feature data sets, use the plurality of quantum feature data sets to respectively train and maintain a plurality of local machine learning models distributed across the plurality of domains, and aggregate quantum parameters of the plurality of local machine learning models. The quantum federated learning system may utilize one of a variational quantum eigen solver, a quantum approximate optimization algorithm, or a hybrid quantum-classical algorithm. The plurality of local machine learning models comprises a quantum support vector machine or a quantum neural network implemented with quantum bits. The quantum federated learning system may transfer the quantum parameters between the plurality of domains with quantum cryptography. The quantum federated learning system may dynamically select the quantum parameters to encrypt based on sensitivity information represented by the quantum parameters.

The QEDM system may use the aggregated quantum parameters of the plurality of local machine learning models to continuously update a global quantum model with the plurality of domains represented as quantum states and with interdependencies between the plurality of domains mapped to entanglements between the quantum states. The QEDM system may then analyze the entangled quantum states to identify inter-domain gaps in connectivity between the plurality of domains and identify optimizations to the plurality of domains to eliminate or minimize the identified inter-domain gaps. The QEDM system may implement a quantum circuit with quantum bits representing the quantum states. The decision determination system may assign priorities to the identified inter-domain gaps identified by the QEDM system and, based on the identified optimizations and the priorities, use a predictive artificial intelligence model to generate a remediation process for one or more of the inter-domain gaps.

As another example, an embodiment that incorporates quantum gradient descent landscape navigating may include a quantum-based system for optimizing domains in a distributed network, wherein the quantum-based system comprises a plurality of subsystems implemented with at least one classical computer, at least one quantum computer, and at least one memory that stores computer-executable instructions. The quantum computer may use superconducting materials, photonics, neutral atoms, trapped ions, quantum dots, helium electrons, or nitrogen-vacancy diamonds to implement quantum bits representing the quantum states. The plurality of subsystems may include a source domain system, a quantum federated learning system, a quantum gradient descent landscape navigator (QGDLM) system, and a decision determination system. The computer-executable instructions, when executed by the at least one classical computer and the at least one quantum computer may cause each of the subsystems to perform certain functions. For example, the source domain system and the quantum federated learning system may perform the same functions described in the previous QEDM example. The QDCLN system may initialize quantum bits to superposition states that represent configurations of the plurality of domains in a global quantum model. The model may be based on the aggregated quantum parameters of the plurality of local machine-learning models.

The QDCLN system may further define a cost function that quantifies distances between domains within the distributed network, construct a quantum gradient descent circuit for the cost function, iteratively apply the quantum gradient descent circuit to the quantum bits to identify a minimum of the cost function, observe the quantum bits after the iterative application of the quantum gradient descent circuit, and determine optimizations to the plurality of domains based on the observed quantum bits. The distances may indicate a degree of relatedness between performance metrics of each of the plurality of domains. In some examples, at least one of the distances indicates an inverse relationship such that when one metric increases, a related metric decreases. The decision determination system may assign priorities for the optimizations identified by the QGDLN system, and, based on the determined optimizations and priorities, a predictive artificial intelligence model may be used to generate an optimization process for the plurality of domains.

The following description and claims, in conjunction with the drawings-all integral parts of this specification-will clarify various features and characteristics of the current technology. Like reference numerals in the figures correspond to similar parts, enhancing understanding of the technology's processes of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple interconnected devices. However, it is important to acknowledge that the drawings primarily serve descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 depicts a block diagram of a distributed network comprising multiple interrelated nodes.

FIG. 2 depicts a system diagram for detecting and optimizing inter-domain gaps between nodes in a distributed network.

FIG. 3 depicts a process flow that may be implemented with the system illustrated in FIG. 2 for detecting inter-domain gaps between nodes in a distributed network, determining optimizations, and applying the optimizations to the network.

FIG. 4 depicts a process flow for a quantum domain entanglement mapper that maps correlations between nodes in a distributed network to entanglements between qubits in a quantum model.

FIG. 5 depicts a process flow for a quantum gradient descent landscape navigator that applies a quantum descent process to a cost function for an inter-domain network landscape by applying quantum computing techniques.

FIG. 6 depicts an example environment in which various aspects may be implemented in accordance with one or more aspects described herein.

### DETAILED DESCRIPTION

Examples of systems are presented that detect, flag, and correct data anomalies in real-time in an inter-domain network, making it an essential tool for organizations that rely on AI for critical decision-making processes.

The quantum entanglement-driven anomaly detection in this invention is particularly effective in identifying false positives and negatives. False positives occur when the system incorrectly flags valid data as anomalous, while false negatives occur when the system fails to detect compromised data. By leveraging quantum entanglement techniques, the system can detect subtle patterns and correlations within the model-matrix computations that might otherwise go unnoticed. This ensures that anomalies are detected accurately, reducing the occurrence of false positives and negatives and improving the overall reliability of the AI system.

Various aspects employ a novel Source Domain Layer (SDL) system, a Quantum Federated Learning Layer (QFL) system, a Quantum Entangled Domain Mapper (QEDM), and/or a Quantum Gradient Descent Network Landscape Navigator (also referred to as Quantum Gradient Decent landscape Navigator) (QGDNL) that identify network gaps and optimize inter-connectivity for enhanced decision-making efficiency across distributed networks.

The SDL ensures the quality and consistency of data collected from various nodes within a distributed network. The SDL includes comprehensive node data collection and meticulous data preprocessing to handle inconsistencies and enhance data quality. By standardizing the input from each node, The SDL enables more reliable processing by the QFL and subsequently by the QEDM and/or QGDLN.

The QFL represents a significant leap forward by combining quantum computing with federated learning principles. In this layer, multiple parties can collaboratively train a machine learning model while retaining their raw data, thus maintaining privacy and security. Applying quantum bits (qubits) dramatically improves computational efficiency, resulting in faster training times and enhanced model performance. This synergistic melding of quantum computing and machine learning provided by the QFL allows for expansive knowledge generation that arises from the collective intelligence of distributed nodes.

The QEDM and QCDLN systems integrate quantum technologies with advanced data processing and machine learning techniques, transforming how data is managed and utilized across multiple domains.

The QEDM system leverages quantum entanglement principles to create a comprehensive mapping of domain features, identifying connectivity gaps and fostering adaptive cross-domain strategies. QEDM utilizes an algorithm that leverages the principles of quantum entanglement to analyze and map domain features within a network. The idea behind QEDM is to map dependencies between different domains within a network as entanglements between quantum bits and to use quantum modeling to see how changes in one domain affect or do not affect other domains. Gaps in network connectivity are identified by monitoring the entanglement effects in the modeling, which can be indicative of potential vulnerabilities or inefficiencies.

The QGDLN system employs innovative quantum mechanics techniques to optimize the identification of these gaps by minimizing designated cost functions. The QGDLN solver combines principles from quantum computing with gradient descent optimization processes. In QGDLN, a cost function is defined that quantifies distances between nodes within the network. The “distance” is a measure of performance (latency, error rate, data volume, total time, etc.) of interactions between network nodes. Quantum computing is used to iteratively calculate the gradient of the cost function and find (descend to) the optimal cost.

Individually or together, these components provide a deeper understanding of inter-domain relationships-a novel contribution to the field- and empower adaptive, real-time decision-making across complex networks. Through AI-predictive analytics and collaborative decision algorithms, the described systems are transformative over prior art systems in how multifaceted data is interpreted and acted upon to create more intelligent and resilient decision systems.

The description of various example embodiments herein is intended to achieve the goals previously outlined, referencing the illustrations included in this disclosure. These illustrations depict multiple systems and processes for implementing the disclosed information. It should be recognized that alternative implementations are possible, and modifications to both structure and functionality may be made. The description details various connections between elements, which should be interpreted broadly. Unless explicitly stated otherwise, these connections can be direct or indirect and may be established through wired or wireless processes. This document does not aim to restrict the nature of these connections.

In various configurations, terms such as “computers” and “machines” refer to devices that may be general-purpose or specialized for specific functions, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in volatile and non-volatile memory and may function autonomously or respond to specific triggers. These elements can be consolidated or distributed across multiple devices and stored in accessible memory systems such as distributed databases, big data infrastructures, blockchains, or distributed ledgers.

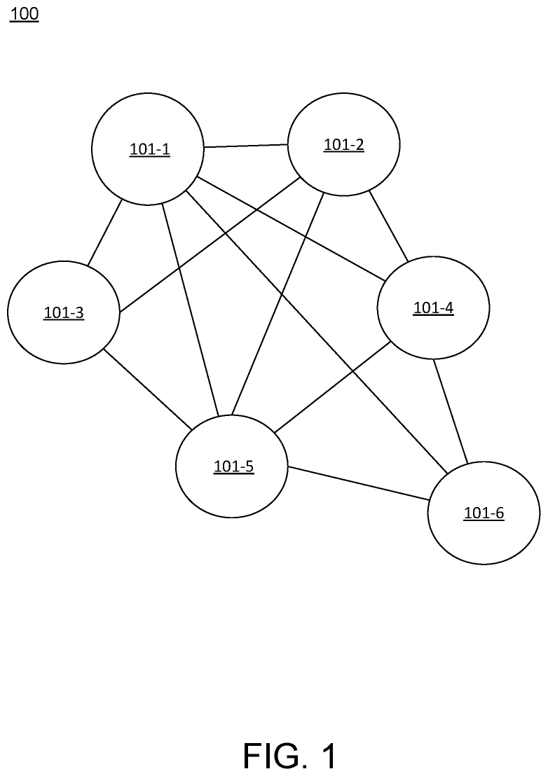

FIG. 1 depicts an illustrative distributed network environment with a plurality of nodes 101-1 through 101-6. The nodes, for example, may include devices such as servers, computers, network memory, etc., interconnected through communication links (represented by the lines between the nodes).

Each node or combination of one or more nodes may form different domains, for example, operating as separate autonomous systems that exchange information through inter-domain connections for collectively performing processes and providing services. Although a limited number of nodes and interconnections between nodes are shown, any number of systems or devices may be used without departing from the disclosure.

For example, in financial services, node 101-1 may form a banking service domain that provides for the processing of credit cards, vehicle loans, home loans, etc., node 101-2 may form a payment processing domain for receiving and processing payments for services provided by the banking service domain 101-1, node 101-3 may provide a compliance domain that verifies that transactions performed by other domains are compliant with technical and administrative rules, and node 101-4 may provide a risk management domain that calculates the reliability, financial, and other risks of services provided by the other domains.

The nodes/domains may be configured to provide a user interface through which a user may perform data processes, transfer data, or conduct a transaction. For example, a banking service domain may be configured to receive an indication of a request from a user (e.g., card reader initiation of transaction), display one or more user interfaces, provide audio output, receive user input via one or more input devices (e.g., touchscreen, keypad, or the like), receive audio user input, process transactions (e.g., accept deposits, dispense funds, or the like), and the like. An example banking service domain may include an Automated Teller Machine (ATM), sales or teller terminal, personal computer or laptop within a residence or business (e.g., connected via Wifi), point-of-sale (POS) system, smartphone connected through a cellular network, or other computing device. Nodes 101-1 through 101-6 may include back-end machines from which systems hosted on the distributed network may be managed, controlled, or implemented.

Each domain may perform several network management functions, such as user access/authentication verification, resource management, maintenance management, anomaly detection, anomaly alerting, data rate limiting, etc. Each domain requires information from the other domains to efficiently, timely, and effectively provide its respective services and perform administrative functions. For example, each domain (e.g., nodes 101-1 to 101-6) may receive communications from users or other domains that include data transaction requests and process those transactions and/or perform other tasks related to data transactions (e.g., such as detecting unauthorized transactions, modifying data links, generating derivative data, etc.). Each node or domain may have different capabilities, data formats, rules, regulations, or other technical limitations for storing and transferring data and conducting transactions associated with accounts (e.g., bank accounts, streaming service accounts, company employee accounts, etc.). The capabilities, data formats, rules, regulations, or other technical limitations may differ for transferring data within a region and from region to region. Each inter-domain connection (e.g., between 101-3 and 101-4) may be restricted; thus, transferring data between such domains may require transferring data through one or more intermediate domains (e.g., 101-1 or 101-5).

Data may be transmitted between nodes 101-1 to 101-6 using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. Databases may be distributed across multiple network memories connected through the distributed network environment. They may utilize tamper-proof data structures, such as blockchains (or other linked lists), sidechains (or different lists of linked lists), or directed acyclic graphs, such as tangles or hash graphs. Tamper-proof encoding may alternatively or additionally use lattice-based cryptography, code-based cryptography, and multivariate cryptography. Tamper-proof encoding may include quantum-resistant encryption.

The inter-domain connections may include different types of networks, such as a local area network (LAN), a wide area network (WAN), a wireless telecommunications network, digital subscriber line (DSL) networks, frame relay networks, asynchronous transfer mode (ATM) networks, virtual private networks (VPN), and/or any other communication network or combinations thereof. Inter-domain connections may also include associated “network equipment” such as access points, ethernet adaptors (physical and wireless), firewalls, hubs, modems, routers, and/or switches located inside the network and/or on its periphery, as well as software executing on any of the foregoing. The inter-domain connections shown are illustrative, and any means of establishing a communications link between the computer platforms may be used. The existence of any of various network protocols, such as TCP/IP, Ethernet, FTP, HTTP, and the like, and various wireless communication technologies, such as GSM, CDMA, WiFi, and LTE, is presumed. The computing platforms described herein may be configured to communicate using any network protocols or technologies.

Communication issues that negatively impact the exchange of information between nodes or domains are referred to as inter-domain gaps. Identifying these gaps in the network is crucial for improving security, particularly against source address spoofing attacks. These gaps can arise due to various factors, including inadequate source address validation mechanisms and asymmetric routing.

One example of an inter-domain network gap can be illustrated through the concept of asymmetric routing. Consider two Autonomous Systems in this scenario, AS 1 and AS 2. AS 1 may be a client device of AS 2, and they exchange routing information. However, due to specific routing policies or configurations (like NO_EXPORT), particular prefixes indicated by AS 1 may not propagate correctly to AS 2. Suppose a packet from AS 1 with a source address that belongs to its prefix arrives at AS 2 but takes an unexpected route back to AS 1 (due to asymmetric routing). In that case, it may lead to situations where packets are improperly blocked or permitted. For instance, if AS 2 employs Strict Unicast Reverse Path Forwarding (uRPF) as its source address validation mechanism, it might block legitimate packets from AS 1 because it does not recognize the incoming interface as valid for that source address due to the lack of proper prefix propagation. This situation exemplifies how gaps in inter-domain networks can lead to improper blocking of legitimate traffic while failing to prevent spoofed packets from entering the network, compromising security and operational efficiency.

Identifying inter-domain network gaps involves recognizing issues like asymmetric routing that can hinder effective source address validation across different Autonomous Systems. Other potential inter-domain network gaps include routing inefficiencies, network congestion, redundancy issues, configuration errors, etc. Examples of routing inefficiencies may include suboptimal routing paths that may lead to increased latency or packet loss. Examples of network congestion may include high traffic loads on certain links that can cause bottlenecks, leading to delays in data transmission. Examples of redundancy issues may include a lack of redundancy that creates single points of failure, which may disrupt connectivity if a device fails. Examples of configuration errors may include misconfigurations in routing tables or access control lists that prevent proper communication between devices.

Additional potential inter-domain gaps include network segmentation issues, insufficient access controls, outdated hardware and software, inadequate monitoring and logging, poorly configured firewalls, unsecured Internet-of-things (IoT) devices, incomplete incident response plans, etc. Network segmentation issues relate to the lack of proper segmentation, which can lead to unauthorized access between different parts of the network. This can allow attackers to move laterally within the network once they gain access to one segment. Insufficient access controls, including weak or misconfigured access controls, can result in users having more privileges than necessary, which increases the probability of data breaches and insider threats. Outdated hardware and software can create vulnerabilities that are useable by attackers. Regular updates and patch management are crucial to mitigate these probabilities. Inadequate monitoring and logging may lead to difficulty detecting unusual activities or breaches in real time, leading to a delayed response to incidents. Poorly configured firewalls leave open ports that should be closed, allowing unauthorized traffic into the network. Unsecured and increased number of IoT devices poses a risk if they are not adequately secured, as they can serve as entry points for attackers into the broader network. Incomplete incident response plans may hinder effective response to security incidents when they occur.

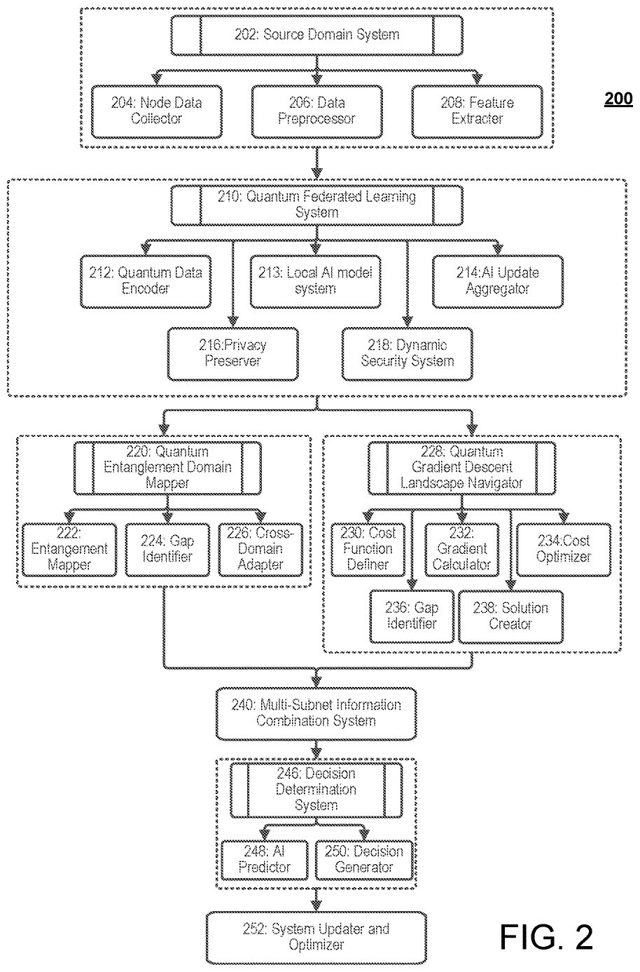

FIG. 2 depicts a system diagram representing a comprehensive architecture for detecting and optimizing inter-domain gaps between nodes in a distributed. In today's complex distributed networking systems, machine problems can arise due to various factors, including hardware failures, software bugs, and environmental conditions. To effectively diagnose and resolve these issues, it is essential to leverage multiple sources of information that can provide valuable insights into the problem. However, current approaches in unsupervised machine learning often focus on a single source of information, such as sensor data or network logs, which can lead to incomplete and inaccurate diagnoses.

The challenge lies in combining these multiple sources of information to effectively capture the system's complexities and enable more accurate and informed decision-making. System 200 addresses this challenge with a distributed networking component that seamlessly integrates and fuses diverse sources of information, including sensor readings, network traffic patterns, and maintenance records. By addressing this challenge, system 200 creates a more robust and reliable diagnostic framework that enables network operators to quickly identify and resolve issues, reducing downtime and improving overall system performance.

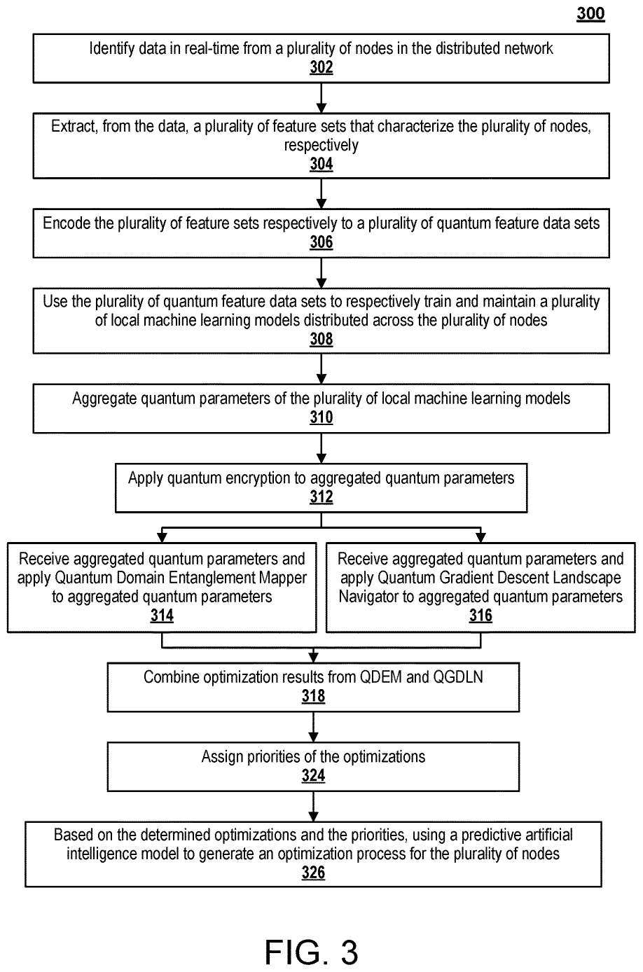

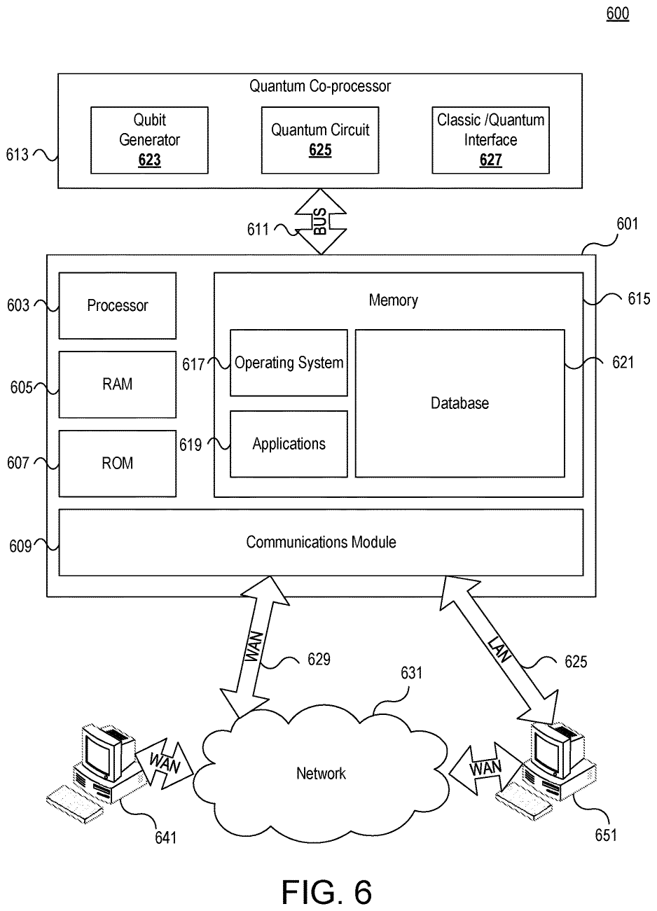

FIG. 2 comprises several sub-systems, each of which may be implemented by a node illustrated in FIG. 1 and/or by the computing environment 600 illustrated in FIG. 6. Processing by system 200 may include performing the process flow 300 depicted in FIG. 3 for detecting inter-domain gaps between nodes in a distributed network, determining optimizations, and applying the optimizations to the network.

System 200 may include a Source Domain Layer (SDL) system 202. The SDL 202 ensures the quality and consistency of data collected from various nodes within a distributed network. The SDL includes a comprehensive node data collector 202, which may perform step 302 to identify data in real-time from a plurality of nodes (e.g., 101-1 to 101-6) in the distributed network. The data may be related to the services and administrative functions performed by each node or domain as described above with respect to FIG. 1. The data sources within each domain may include real-time sensors, distributed networks, or batch data streams, ensuring comprehensive coverage of scenarios relevant to the collective operation of the domains. The diversity of the data allows the system to address a wide array of challenges associated with interdomain gaps in the network interconnections. By collecting data from such varied origins, the system ensures that it is not limited to a single data type or source, allowing for a robust and adaptable architecture.

Data preprocessor 206 in SDL 202 may preprocess the data to handle inconsistencies and enhance data quality. For example, preprocessor 206 may identify and remove irrelevant data to optimize the system's computational efficiency by removing data that does not contribute to the system processing or predictions about the performance of the domains or inter-domain connections. Preprocessor 206 may further clean the data by autonomously detecting, removing, and/or correcting inconsistencies, noise, or potential errors in the data. This cleaning process ensures that the dataset is entirely reliable and ready for use in critical AI and quantum computations. The automated nature of this process ensures that the system can handle large volumes of data without manual intervention, which enables efficient scaling of the system to enterprise-level applications. Following preprocessing, feature extractor 208 in SDS 202 may extract features from the preprocessed data that will be used for further AI and quantum processing. For example, feature extractor 208 may perform step 304 of process 300 by extracting, from the data, a plurality of feature sets that characterize the plurality of nodes, respectively. SDS 202, including subsystems 204, 206, and 208, may be distributed across multiple nodes or within multiple domains, for example, such that each node or domain performs identification, preprocessing, and extraction for data that it stores or generates.

Once SDS 202 collects and preprocesses the data and extracts features from the data, system 200 includes a Quantum Federated Learning Layer (QFL) system 210. The QFL 210 represents a significant leap forward by combining quantum computing with federated learning principles. In this layer, multiple parties (e.g., nodes and domains) can collaboratively train a machine learning model while retaining their raw data, thus maintaining privacy and security. Applying quantum bits (qubits) dramatically improves computational efficiency, resulting in faster training times and enhanced model performance. This synergistic melding of quantum computing and machine learning provided by the QFL allows for expansive knowledge generation that arises from the collective intelligence of distributed nodes.

The QFL 210 may include a quantum data encoder 212, which may perform step 306 in process 300 for encoding the plurality of feature sets (e.g., generated by feature extractor 208) to a plurality of quantum feature data sets, respectively. Local AI model system 213 in QFL 210 may then perform step 308 of process 300, which uses the plurality of quantum feature data sets to train and maintain a plurality of local machine learning models distributed across the plurality of nodes. Each local machine learning model, for example, may characterize and/or predict the performance of a respective domain. The local machine learning models may form or be part of a distributed AI model. Training or the local AI models may be performed within each respective domain. They may involve processing each quantum feature data set with an AI model encoded as a quantum circuit to generate quantum model parameters. Training the models may include using \ a variational quantum eigen solver, a quantum approximate optimization algorithm, or a hybrid quantum-classical algorithm. The plurality of local machine learning models may comprise a quantum support vector machine or a quantum neural network implemented with quantum bits.

QFL 210 includes an AI update aggregator 210, which may perform step 310 of process 300 for aggregating the quantum parameters of the plurality of local machine learning models together for further processing. The quantum parameters may be measured and converted to classical data before aggregation or aggregated together as qubits.

QFL 210 may include a privacy preserver system 216, which maintains the privacy of each domain by limiting access to the raw data to within the respective domain and only passing the quantum parameters to aggregator 214. QFL may also include a dynamic security system 218, which applies different encryption and security protocols to the data processed in QFL 210. For example, the dynamic security system 218 may perform step 312 of process 300 for applying quantum encryption (e.g., post-quantum encryption algorithms) to the aggregated quantum parameters during and after aggregation. The encryption and other security protocols may be dynamically applied by 218 by being adapted to the sensitivity of the data being processed and ensuring that the data remains protected from unauthorized access or tampering throughout its lifecycle.

The QFL architecture ensures that data privacy is maintained even as the system aggregates data from disparate sources. This approach allows for decentralized data handling while still offering centralized processing benefits. The federated nature of the server also means that sensitive or private data does not need to leave its original location, enhancing privacy and security while still enabling efficient AI processing. This structure is especially important for systems handling sensitive information across multiple jurisdictions, where data privacy regulations may vary.

After processing by QFL 210, the aggregated parameters may be further processed by Quantum Entangled Domain Mapper (QEDM) 314 and/or a Quantum Gradient Descent Landscape Navigator (QGDLN) 316 to identify inter-domain gaps in the distributed network and/or optimize inter-connectivity for enhanced decision-making efficiency across distributed networks. The QEDM 220 and QCDLN 228 systems integrate quantum technologies with advanced data processing and machine learning techniques, transforming how data is managed and utilized across multiple domains. Through AI-predictive analytics and collaborative decision algorithms, the described systems are transformative over prior art systems in how multifaceted data is interpreted and acted upon to create more intelligent and resilient decision systems.

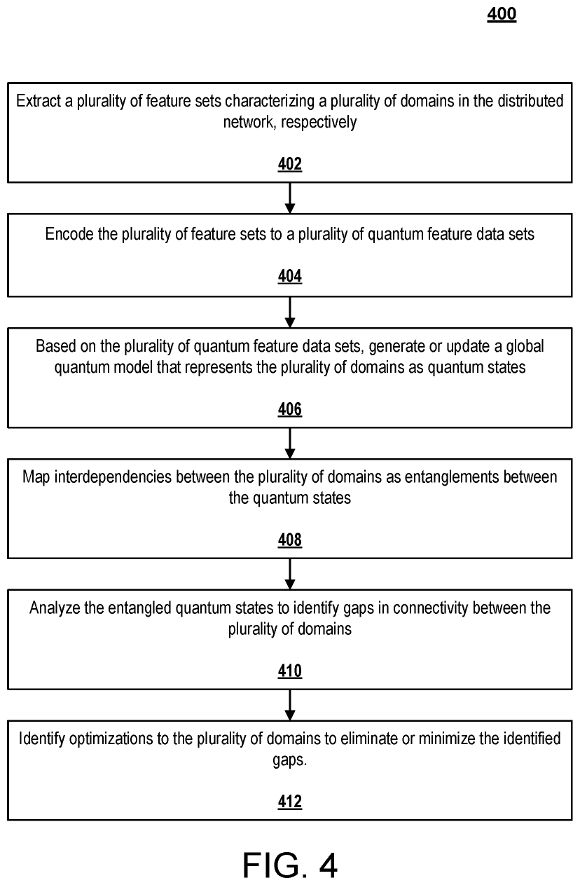

The QEDM 220 leverages quantum entanglement principles to create a comprehensive mapping of domain features, identifying connectivity gaps and fostering adaptive cross-domain strategies. The QEDM 220 may perform step 314 of process 300 to receive the aggregated quantum parameters and apply quantum domain entanglement mapping to aggregated quantum parameters to identify interdomain gaps. QEDM is further described with respect to process 400, depicted in FIG. 4

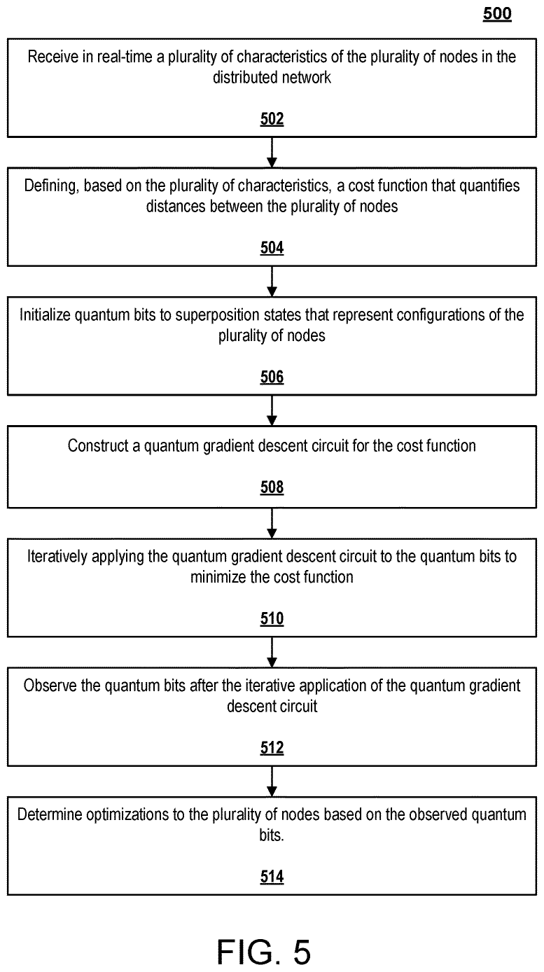

The QGDLN 228 employs innovative quantum mechanics techniques to optimize the identification of these gaps by minimizing designated cost functions. QGDLN 228 may perform step 316 of process 300 to receive the aggregated quantum parameters and apply quantum gradient descent landscape navigating to the aggregated quantum parameters to identify interdomain gaps and optimizations to the domains. QGDLN is further described with respect to process 500, depicted in FIG. 5.

System 200 may include a multi-subnet information combination system 240, which may perform step 318 of process 300 for combining the processing results by QEDM 220 and/or QGDLN 228. Processing results may include identified inter-domain gaps in the distributed network, particular optimizations to domains, or interconnections between domains to correct or minimize the gaps. Combining the results of these systems facilitates a deeper understanding of inter-domain relationships-a novel contribution to the field—but also empowers adaptive, real-time decision-making across complex networks. The proposed system transforms how multifaceted data is interpreted and acted upon through AI-predictive analytics and collaborative decision algorithms, creating more intelligent and resilient decision systems. By leveraging the principles of quantum physics and AI, the system can identify even subtle variances in the inter-domain connections.

System 200 may include a decision determination system 246, which may receive the combined processing results. Decision determination system 246 may include an AI predictor, which may leverage AI predictive models to perform step 324 of process 300 for assigning priorities to identified gaps and optimizations provided in the combined results. For example, the AI predictive model may prioritize certain optimizations over others based on the criticality (e.g., security event) of the gaps the optimizations fix or may prioritize optimizations providing the most significant overall benefit (e.g., most delay mitigation) to the network and/or domains.

Based on the determined optimizations and the priorities, decision generator 250 within decision determination system 246 may then perform step 326 of process 300, which uses a predictive and/or generative AI model to generate an optimization process for the plurality of nodes. A system updater and optimizer 252 of system 200 may then implement the optimization process, for example, by sending a sequence or group of instructions to various nodes or domains to modify operation or communication between domains.

While process 300 of FIG. 3 is described above as being performed by system 200 of FIG. 2, process 300 is not limited to such an implementation, and other systems or components may perform process 300. For example, process 300 may be performed by a quantum-based system comprising a plurality of subsystems implemented with at least one classical computer, at least one quantum computer, and at least one memory that stores computer-executable instructions. The computer-executable instructions, when executed by at least one classical computer and at least one quantum computer, may cause the quantum-based system to perform the steps of process 300

FIG. 4 depicts a process flow 400 for a quantum domain entanglement mapper that maps correlations between nodes in a distributed network to entanglements between qubits in a quantum model. Process 400, for example, may be used for performing step 314 in FIG. 3. Process 400 may be performed by a quantum-based system comprising a plurality of subsystems implemented with at least one classical computer, at least one quantum computer, and at least one memory that stores computer-executable instructions. The computer-executable instructions, when executed by at least one classical computer and at least one quantum computer, may cause the quantum-based system to perform the steps of process 400.

Process 400 provides an advanced computational framework that leverages principles of quantum mechanics, particularly quantum entanglement, to analyze and map complex networks. This QEDM process is especially relevant in identifying gaps or vulnerabilities within network structures, which can be crucial for sectors such as finance, telecommunications, and cybersecurity. To identify gaps or weaknesses in network configurations, the QEDM process analyzes the relationships between various nodes (or points) within a network by mapping the relationships to quantum entanglements. By utilizing quantum algorithms, QEDM can process vast amounts of data more efficiently than classical computing processes. This capability allows it to detect anomalies or vulnerabilities that could lead to potential failures or security breaches.

Process 400 begins with step 402, in which the quantum-based system extracts a plurality of feature sets characterizing a plurality of domains in the distributed network, respectively. For example, step 402 may be performed as described with respect to source domain system 202 in FIG. 2. As an example, in the context of a banking transaction processing, process 200 may be applied to a bank's transaction system consisting of multiple nodes including ATMs, online banking servers, payment gateways, and user databases. Each node communicates with others to process transactions securely. Step 402 may include extracting features (e.g., performance metrics) related to the communications between nodes.

In step 404, the quantum-based system may encode the plurality of feature sets to a plurality of quantum feature data sets. This may involve generating qubits corresponding to the plurality of feature sets and initializing the qubits to superposition states. Each quantum feature data set may correspond to a respective domain or a respective interconnection between two or more domains.

In step 406, the quantum-based system may, based on the plurality of quantum feature data sets, generate a global quantum model that represents the plurality of domains as quantum states. In step 408, the quantum-based system may map interdependencies between the plurality of domains as entanglements between the quantum states. For example, in the banking transaction processing scenario, a bank quantum-based computing device may create a quantum-entangled map of its network. This map may represent all possible interactions between nodes during a transaction. For instance, when a user initiates a transfer from their account via an ATM, several nodes are involved: the ATM itself communicates with the bank's server and accesses user data from the database. Step 406 may generate a combination of qubits that represent the functions of the ATM, server, and database, and step 408 may represent each interaction or relationship between the ATM, server, and database by one or more entanglements between the qubits. The mapping may include deriving and applying a quantum circuit to the qubits to implement the entanglements.

In step 410, the quantum-based system may analyze the entangled quantum states to identify gaps in connectivity between the plurality of domains. As transactions occur, QEDM may analyze real-time data flows between these nodes. For example, if there is an unusual delay or failure in communication between the ATM and the server-perhaps due to maintenance on one node-QEDM can quickly identify this gap as it disrupts normal transaction flow. Step 410 may involve measuring one or more of the qubits to convert the information into classical data.

In step 412, the quantum-based system may identify optimizations to the plurality of domains to eliminate or minimize the identified gaps. For example, upon detecting the gap, the bank's systems may take (e.g., autonomously) proactive measures such as rerouting traffic through alternative pathways or alerting users about potential delays before they experience issues during their transactions. Such measures, for example, may be applied by decision determination system 246 and/or system updated and optimizer 252 in system 200, depicted in FIG. 2. By continuously monitoring such interactions using quantum algorithms capable of processing complex datasets rapidly, QEDM helps ensure that any unauthorized access attempts are detected immediately due to changes in expected patterns of node interactions. In summary, QEDM process 200 provides the ability to analyze complex interdependencies within network systems using quantum principles, thus serving as a powerful tool for identifying gaps that could affect critical operations, such as those in banking transactions.

One example application of QEDM is in the context of a banking sector maintaining security and efficiency in transaction processing. Financial institutions face challenges such as identifying fraudulent transactions, optimizing transaction approval processes, and ensuring seamless communication between various operational domains (e.g., payment processing, user service, compliance, and risk management). Using QEDM, relevant features from each operational domain in a banking environment may be extracted. For instance, extracted features may include one or more of payment processing domain metrics such as transaction volume, average transaction time, failure rates, and fraud detection alerts; user service domain metrics like response time to user queries, user feedback scores, and incidence of transaction disputes; compliance domain metrics related to regulatory checks, audit findings, and risk assessments; and risk management domain metrics reflecting credit risk scores, historical fraud patterns, and anomaly detection rates.

Each domain's extracted features may be represented as quantum states (e.g., by qubits). This method captures the nuances of each domain while allowing for the representation of complex correlations that are not readily observable using classical models. For example, suppose a spike in payment processing delays occurs. In that case, it can be represented as a quantum state that interacts with states from user service (e.g., user server satisfaction ratings) and risk management (e.g., fraud alerts). Using the principles of quantum mechanics, the qubits may be entangled to represent the interdependencies between the domains. The QEDM analyzes the interactions between these quantum states. For instance, a sudden increase in fraud alerts in the payment processing domain may correlate with a decrease in user service satisfaction. The algorithm will establish connections (e.g., entanglements) between these two domains, indicating a potential issue where fraudulent activity may be affecting user trust.

After establishing the mapping, QEDM identifies gaps in connectivity between the banking sector domains. It might reveal that when certain types of transactions are flagged for fraud, there is no corresponding increase in alerts from the risk management domain, suggesting a disconnect in how risks are assessed across domains. This gap could indicate a need for improved communication or data-sharing protocols. Based on the identified gaps, QEDM may suggest optimizations. For instance, QEDM may employ AI models that analyze the identified gaps and recommend adjusting the fraud detection algorithms to incorporate real-time feedback from the risk management domain, enhancing user service training to better handle inquiries related to flagged transactions, fostering trust, and/or allocating additional resources to the compliance department to address emerging patterns of fraud that are not being adequately monitored.

By implementing QEDM, the bank system may achieve a more responsive and adaptive fraud detection and prevention system. This leads to quicker identification of fraudulent activities, improved user satisfaction, and better regulatory compliance. The interconnected mapping helps in understanding the ripple effects of changes across domains, ultimately enhancing the bank's operational efficiency and security posture. The QEDM may identify all devices, connections, and potential vulnerabilities in each domain and between the domains, providing a complete overview of the network and enabling targeted remediation efforts. From this, resultant outcomes may include the generation of a prioritized list of vulnerabilities that informs immediate remediation tasks, improved visibility and easier identification of patterns or breaches, identification of weaknesses before misuse by malicious actors, improved employee awareness, and reduced risk of successful attacks, and clear, actionable steps for responding to security incidents that overall readiness.

In another example, QEDM may be applied in the context of a smart city in which various domains, such as traffic management, public transportation, emergency services, and environmental monitoring, are interconnected. To optimize traffic flow and ensure public safety, the city may employ QEDM to analyze and map these interconnected domains.

In the smart city application, the QEDM processing may begin by extracting relevant metrics from each domain. For example, traffic management metrics may include vehicle count, average speed, traffic light timings, and congestion levels; public transportation metrics may include bus arrival times, passenger load, and route efficiency; emergency services metrics may include response times, active units, and incident locations; environmental monitoring metrics may include air quality indices, noise levels, weather conditions.

Each domain and/or each metric within a domain may be represented as a quantum state (e.g., in qubits) based on the extracted features. For instance, the traffic management system's high vehicle count and low average speed can be represented as a specific quantum state. Similarly, public transportation metrics can be encoded into another quantum state.

Using quantum entanglement principles, the QEDM processing establishes connections between these quantum states (e.g., by generating a quantum circuit). For example, if an increase in traffic congestion (traffic management state) correlates with delays in bus arrivals (public transportation state), the algorithm identifies an entangled relationship. Based on the entanglements, the mapping may reveal that changes in traffic light timing not only affect vehicle flow but also influence bus schedules and emergency vehicle response times.

The QEDM system analyzes the entangled states to identify gaps in connectivity. For instance, if a sudden spike in congestion does not affect emergency response times as expected, this indicates a gap. The algorithm detects that the emergency services domain is not adequately informed about real-time traffic conditions, leading to inefficient routing. Based on the identified gaps, the QEDM system suggests actionable insights, such as resource reallocation (e.g., adjusting traffic light cycles to prioritize emergency vehicles during high congestion periods), configuration modifications (e.g., integrating a real-time data feed from traffic management into the emergency services' routing algorithms to enhance responsiveness), and/or providing public notifications (e.g., informing public transportation systems in real-time of traffic conditions to adjust bus schedules and minimize delays). By employing QEDM, the smart city achieves enhanced coordination between its domains, leading to reduced traffic congestion, improved public transport efficiency, and quicker emergency response times. The interconnected mapping allows for dynamic adjustments, making the entire system more resilient and efficient in real-time operations.

FIG. 5 depicts a process flow 500 for quantum gradient descent landscape navigating (QGDLN). QGDLN combines principles from quantum computing with gradient descent optimization processes specifically tailored to address challenges in networked systems. One goal of QGDLN is to optimize the performance of networks by efficiently navigating through complex loss landscapes that arise in various applications, including machine learning and data processing. In traditional gradient descent, optimization is performed by iteratively adjusting parameters based on the gradient of a loss function. However, as networks grow in complexity, particularly in scenarios involving large datasets or intricate interconnections, conventional processes may struggle to find optimal solutions efficiently. QGDLN leverages quantum mechanics' unique properties-such as superposition and entanglement—to enhance the optimization process.

Process 500, for example, may be used for performing step 316 in FIG. 3. Process 500 may be performed by a quantum-based system comprising a plurality of subsystems implemented with at least one classical computer, at least one quantum computer, and at least one memory that stores computer-executable instructions. When executed by at least one classical computer and at least one quantum computer, the computer-executable instructions may cause the quantum-based system to perform the steps of process 500.

Process 500 may begin with step 502, in which a quantum-based system may receive in real-time a plurality of characteristics of the plurality of nodes in the distributed network. For example, in the context of banking transactions, a bank may process millions of transactions daily, including deposits, withdrawals, compliance checks, and transfers across various branches and digital platforms. Executing the transactions may pose challenges related to network latency, transaction failures, and inconsistent throughput, especially during peak hours. These issues have resulted in user dissatisfaction and potential revenue loss. In step 502, the monitored characteristics may include the transaction data and the metrics such as latency, failures, etc.

In step 504, the quantum-based system may define, based on the plurality of characteristics, a cost function that quantifies distances between the plurality of nodes. For example, the transaction processing system may be modeled as a network where each node represents a server handling specific tasks, and the cost function may be defined based on transaction completion time and user satisfaction metrics. The distances may indicate, for example, a degree of interrelatedness or dependency between performance metrics of each of the plurality of domains. The distances may indicate a proportional or inversely proportional relationship. In some examples, the distance may indicate a direct or inverse relationship (e.g., represented by a positive or negative distance), such that when one metric increases the related metric increases or decreases, respectively.

In step 506, the quantum-based system may initialize quantum bits to superposition states (e.g., by applying one or more Hadamard gates) that represent configurations of the plurality of nodes and/or interconnections between the plurality of nodes. In step 508, the quantum-based system may construct a quantum gradient descent circuit for the cost function to be applied to the qubits.

In step 510, the quantum-based system may iteratively apply the quantum gradient descent circuit to the quantum bits to minimize the cost function. For example, the gradients needed for optimization can be computed using quantum algorithms that offer exponential speedups over classical counterparts. For instance, techniques like the Quantum Approximate Optimization Algorithm (QAOA) can be employed to derive gradients more efficiently. Through superposition, multiple configurations (e.g., states and functionality of the nodes and states and functionality of the connections between the nodes) of the network are evaluated simultaneously, for example, with the quantum algorithm calculated gradients indicating how changes in server loads or routing paths affect transaction times. The quantum-based system may iteratively update its configuration based on these gradients (e.g., by descending the gradient of the network landscape represented by the cost function) until an optimal setup is found that minimizes delays.

In step 512, the quantum-based system may observe the qubits after the iterative application of the quantum gradient descent circuit. The observation converts the qubits to classical data that can be read out by a classical computer.

In step 514, the quantum-based system may determine optimizations to the plurality of nodes based on the observed quantum bits. For example, the optimization may include reconfiguring server loads to balance transactions more effectively across different nodes, upgrading network hardware in branches with high failure rates or latency issues, or implementing load balancers or optimizing routing algorithms to streamline transaction paths during peak hours.

One example application of QGDLN is in the context of a large multinational bank processes millions of transactions daily, including deposits, withdrawals, transfers across various branches and digital platforms, etc. The bank may be facing challenges related to network latency, transaction failures, and inconsistent throughput, especially during peak hours. These issues may cause user dissatisfaction and potential revenue loss. Using QGDLN, a cost function may be defined (e.g., by the bank's IT team) that quantifies the overall performance of their transaction processing network. This function may incorporate metrics such as: latency differences between different transaction routes (e.g., local vs. international), throughput discrepancies during peak and off-peak hours, and error rates in transaction processing, which lead to failed transactions. The goal may be to minimize this cost function to enhance the overall efficiency of the transaction network.

The QGDLN algorithm initializes quantum states that represent various configurations of the transaction processing network. These states are informed by current performance metrics, such as server loads, transaction volumes, and operational capacity. Utilizing quantum superposition, QGDLN (e.g., as shown in process 300 and 500) explores multiple network configurations simultaneously. By leveraging quantum interference, the algorithm calculates gradients that indicate how adjustments in network configuration could reduce the cost function more effectively than traditional processes, which would analyze one configuration at a time.

The algorithm iteratively applies quantum operations to mimic gradient descent steps. It updates the parameters of the network configuration based on the calculated gradients, continuously seeking to minimize the cost function. This rapid adjustment allows the bank to respond dynamically to fluctuations in transaction demand and network performance. As QGDLN optimizes the network, it identifies significant drops in the cost function and observes where improvements plateau or worsen. For instance, it may reveal that certain transaction routes experience persistent high latency due to underutilized servers or outdated network hardware, indicating areas that require immediate attention. The minimization of the cost function suggests actionable solutions. For example: reconfiguring server loads to balance transactions more effectively across different nodes, upgrading network hardware in branches with high failure rates or latency issues, implementing load balancers or optimizing routing algorithms to streamline transaction paths during peak hours as further discussed below.

By employing the QGDLN algorithm, the bank may successfully enhance its transaction processing network. For example, latency may be reduced by 30%, error rates reduced significantly, and overall throughput improved, leading to increased user satisfaction and retention. The bank may now be better equipped to handle peak transaction volumes, ensuring a seamless banking experience for its users.

As another example, QGDLN may be applied in the context of a financial services company that processes thousands of transactions daily. The company aims to optimize resource utilization and reduce transaction costs. The system monitors various resources to analyze how they affect transaction execution and to identify areas for improvement. In the table shown below, three use cases of the financial services company are provided-payment processing, fund transfer, and loan approval. For each use case, resource utilization and performance metrics of the network are given.

| | Use Case 1: | | Use Case 2: | | Use Case 3: | |
|---|---|---|---|---|---|---|
| Parameters | Payment Processing | | Fund Transfer | | Loan Approval | |
| Data Volume | 500 | MB | 300 | MB | 800 | MB |
| Error Rate | 0.50% | | 0.20% | | 0.80% | |
| Execution Time | 2.5 | seconds | 3.1 | seconds | 5.0 | seconds |
| Memory Utilization | 75% | (of 16 GB) | 80% | (of 16 GB) | 90% | (of 16 GB) |
| Fault Detection | 2 | faults detected | 5 | faults detected | 3 | faults detected |
| CPU Utilization | 65% | | 70% | | 85% | |
| Network Latency | 150 | ms | 200 | ms | 250 | ms |
| Disk I/O | 100 | IOPS | 150 | IOPS | 200 | IOPS |

| | | | |
|---|---|---|---|
| Transaction Cost | $0.10 | $0.30 | $0.50 |
| User Satisfaction | 90% | 85% | 80% |

Using the table data, QGDLN optimization can perform various actions, such as:
1. Resource Reallocation: For example, the tool can identify transactions with high memory utilization (e.g., Loan Approval) and allocate additional resources to improve execution time and reduce errors. For transactions with low error rates but high costs (e.g., Fund Transfer), the tool can suggest strategies to reduce costs without impacting performance.
2. Performance Benchmarking: For example, the tool can compare execution times and resource usage across different use cases to establish benchmarks and identify outliers that require attention. For instance, if the Execution Time for Loan Approval is significantly higher, the tool can analyze which resources (CPU, Memory, etc.) are underperforming.
3. Cost Reduction Strategies: For example, the tool can analyze the correlation between resource utilization and transaction costs to identify cost-saving opportunities. For example, if the Payment Processing has a lower cost but similar data volume as Fund Transfer, strategies could be applied to reduce costs in Fund Transfer by optimizing data handling or execution flow.
4. Fault Management: The tool may monitor fault detection rates to identify transaction types that frequently encounter faults (e.g., Fund Transfer) and optimize the system to minimize these occurrences, thus improving user satisfaction.
5. User Experience Improvement: By analyzing user satisfaction scores alongside resource utilization, the tool can prioritize optimization efforts on transactions that impact user experience the most.

By implementing proposed monitoring system and analyzing the data in the above-mentioned table, the process can effectively manage resources, reduce transaction costs, and improve overall service quality. While the parameters above are limited for simplicity, the QGDLN processing can ingests and base its cost function on hundreds, thousands or millions of such parameters simultaneously using the quantum computation described above.

In a further example, QGDLN may be applied in the context of a cloud-based video streaming service that is experiencing performance issues during peak usage times, particularly in specific geographic regions. Users may be facing delays, buffering, and inconsistent video quality, which point to potential gaps in network connectivity and resource allocation across their distributed architecture. Application of the QGDLN processing may include:
1. Cost Function Definition: a cost function may be defined that captures the (mathematical) distance between the performance metrics of different network nodes. This function may include parameters such as latency (time taken for data to travel between nodes), throughput (amount of data transmitted successfully), and error rates (instance of failed data packets) for each region where the service operates.
2. Quantum State Initialization: Using current performance metrics above, the QGDLN algorithm initializes quantum states representing various configurations of the video distribution network. Each configuration corresponds to how data is routed through the network's infrastructure, considering the current load and performance of each node.
3. Gradient Calculation: The QGDLN algorithm leverages quantum superposition to calculate gradients across these multiple configurations of the video distribution network simultaneously. For example, it might explore a scenario where data streams are rerouted through alternative nodes, allowing the service to evaluate the potential improvements in user experience across multiple routes at once.
4. Optimization Process: Through iterative quantum operations mimicking gradient descent, the algorithm updates the video distribution network configuration parameters based on the calculated gradients. This might involve adjusting bandwidth allocation or changing routing protocols to optimize connectivity for users in regions experiencing the most significant issues.
5. Gap and Error Detection: As the optimization continues, the QGDLN algorithm may identify network gaps and errors by observing where the cost function shows significant drops-indicating improved performance-versus areas where further changes yield minimal benefit or even degrade performance. For instance, it may reveal that certain nodes are underutilized or that specific routes are consistently slower than expected.
6. Implementation of Solutions: After pinpointing the gaps or deficient elements of the network, the QGDLN algorithm may suggest actionable solutions, such as reconfiguring the network to divert more traffic through underutilized nodes, enhancing the capacity of certain links, or reallocating resources to better match user demand in specific regions.

Because the processing is done in real-time, changes to the network in real-time (e.g., autonomously by an AI control system or by engineers), leading to immediate improvements in streaming quality for users. By applying the QGDLN layer, the streaming service may enhance its network performance, resulting in reduced buffering, improved video quality, and an overall better user experience during peak times. This not only increases user satisfaction but also helps retain subscribers, thereby positively impacting the operation of the networked system. The use of quantum techniques allows for a level of optimization and speed in addressing network gaps that traditional processes could not achieve.

The outcomes of processes 300, 400, and 500 may include identifying (e.g., using AI tools) optimizations for remediating inter-domain network gaps or other deficiencies in the operation of the network based on the QEDM and/or QGDLN processing. Identifying and addressing potential network gaps within an inner-domain is crucial for maintaining the integrity, security, and efficiency of network operations. Remediation strategies may include:
1. Conducting a Comprehensive Network Assessment, including network aping and vulnerability scanning. Network mapping may include creating detailed maps of the existing network architecture to identify all devices, connections, and potential vulnerabilities. AI-driven network mapping tools (e.g., trained based on the QEDM and/or QGDLN processing) may be employed to automatically generate detailed visual maps of the existing network architecture, including the all devices, connections, and potential vulnerabilities. A complete overview of the network, enabling targeted remediation efforts. Vulnerability scanning may include utilizing automated tools to scan for vulnerabilities within the network infrastructure. This includes deploying automated vulnerability scanning tools to identify outdated software, misconfigured devices, and open ports. A prioritized list of vulnerabilities may be generated that informs immediate remediation tasks.
2. Implementing Redundant Pathways, including redundancy planning and load balancing (e.g., designed or implemented with an AI tool that is trained based on the QEDM and/or QGDLN processing). Redundancy Planning may include establishing redundant pathways in the network design to ensure that if one path fails, another can take over without disrupting service. Adding built-in redundancy increases network resilience and uptime. Load Balancing may include the use of load balancers to distribute traffic evenly across multiple servers or pathways, which can help prevent overloads and reduce single points of failure. this may include integrating intelligent load balancers across the network that utilize machine learning to optimize traffic distribution across servers. Load balancing enhances network performance and reduces risk of overloads.
3. Strengthening Access Controls, including user authentication and role-based access control. User Authentication may include implementing strong authentication mechanisms such as multi-factor authentication (MFA) and biometrics to ensure that only authorized users have access to sensitive areas of the network. Strengthening access controls improves access security and minimizes the risk of unauthorized access. Role-Based Access Control includes defining user roles and permissions carefully to limit access based on necessity, reducing the risk of unauthorized access. This may include developing (e.g., using an AI tool that is trained based on the QEDM and/or QGDLN processing) a detailed role-based access control framework using AI analytics to assess user needs and permissions effectively. Improving role-based access control minimizes the risk of insider threats and data leakage.
4. Enhancing Monitoring and Logging, including real-time monitoring and centralized logging. (e.g., using an AI tool that is trained based on the QEDM and/or QGDLN results) Real-Time Monitoring may deploy monitoring tools (including AI monitoring tools) that provide real-time insights into network performance and security incidents. This allows for quick identification of anomalies or breaches in real time, thus providing prompt identification and response to security incidents. Centralized Logging may include maintaining centralized logs for all network activities which can be analyzed for patterns indicative of potential gaps or breaches. The centralized logging system may aggregate logs from all network devices for comprehensive processing, which improves visibility and easier identification of patterns or breaches.
5. Regularly Updating Software and Hardware, including patch management and hardware replacement based on processing with an AI tool that is trained with the QEDM and/or QGDLN results). Patch Management ensures that all software applications and operating systems are regularly updated with the latest patches to protect against known vulnerabilities. This may include establishing an automated patch management system that regularly checks, downloads, and applies updates to all software and operating systems, which reduces exposure to vulnerabilities due to outdated software. Hardware replacement includes upgrading outdated hardware components that may not support current security protocols or performance standards. This remediation may include conducting an inventory assessment of hardware, with recommendations for upgrades based on performance and security capabilities.
6. Conducting Regular Penetration Testing, including simulated attacks and subsequent remediation plans based on the simulated attaches. Regular penetration tests (e.g., designed or implemented with an AI tool that is trained based on the QEDM and/or QGDLN processing) may be performed to simulate attacks on the network infrastructure. This helps identify weaknesses before they can be used by malicious actors. Regular penetration testing exercises, may be scheduled utilizing both internal teams and external experts to simulate various attack vectors. Clear remediation plans may be based on identified weaknesses before use by malicious actors. The remediation plans may be prioritized based on penetration test findings.
7. Employee Training and Awareness Programs, including security awareness training and security response drills. Security awareness training may include provide ongoing training for employees about best practices in cybersecurity, including recognizing phishing attempts and understanding social engineering tactics. An AI-driven training platform AI tool (e.g., and AI model trained based on the QEDM and/or QGDLN processing) may be generated that personalizes cybersecurity training for employees based on their roles and past incidents, which will improve employee awareness and reduced risk of successful attacks. Incident Response Drills may further be identified and conducted to simulate various types of cyber incidents so employees know how to respond effectively in real situations.
8. Implementing Network Segmentation, including segregating sensitive data and implementing firewalls between network segments. Segregating sensitive data may include dividing the network into segments based on sensitivity levels, which enables limiting access to critical data only to those who need it. An AI tool (e.g., trained based on the QEDM and/or QGDLN processing) may be utilized to assess data sensitivity and implement dynamic network segmentation accordingly. The restricted access to sensitive data, reduces risks of data breaches. Implementing firewalls or other security measures between segments may be used to control traffic flow and monitor communications between network segments using AI analytics.
9. Developing an Incident Response Plan. This may include creating (e.g., using an AI tool based on the QEDM and/or QGDLN processing) a comprehensive incident response plan detailing steps for responding to various types of security incidents or breaches. The plan may incorporate AI simulations of potential security incidents for training and provide clear actionable steps for responding to security incidents, improving overall readiness.

FIG. 6 depicts an illustrative operating environment in which various aspects of the present disclosure may be implemented in accordance with one or more example embodiments. Computing System Environment 600 is only one example of a suitable computing environment. It is not intended to suggest any limitation regarding the scope of use or functionality contained in the disclosure. Computing System Environment 600 should not be interpreted as having any dependency or requirement relating to any one or combination of components shown in illustrative Computing System Environment 600. Computing System Environment 600 elements may be used to implement any of the nodes, domains, systems, or devices illustrated in FIGS. 1 and 2 (e.g., 101-1 to 101-6, 202 to 252), or interconnections between these elements, and may be used for performing the processes illustrated in FIGS. 3-6.

Computing system environment 600 may include processor 603 (e.g., a for controlling the overall operation of computing device 601 (e.g., a classical computer) and its associated components, including Random Access Memory (RAM) 605, Read-Only Memory (ROM) 607, communications module 609, and memory 615. Computing device 601 may include a variety of computer-readable media. Computer-readable media may be any available media that may be accessed by computing device 601, may be non-transitory, and may include volatile and nonvolatile, removable and non-removable media implemented in any method or technology for storage of information such as computer-readable instructions, object code, data structures, program modules, or other data. Examples of computer-readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor (e.g., hardware processor) on computing device 601. Such a processor may execute computer-executable instructions stored on a computer-readable medium.

Software may be stored within memory 615 and/or storage to provide instructions to processor 603 for enabling computing device 601 to perform various functions as discussed herein. Software may include program modules such as routines, programs, objects, components, data structures, and the like that perform particular tasks or implement particular abstract data types when executed by one or more processors in a computer or other data processing device. For example, memory 615 may store software used by computing device 601, such as operating system 617, application programs 619, and associated database 621. Also, some or all of the computer-executable instructions for computing device 601 may be embodied in hardware or firmware. Although not shown, RAM 605 may include one or more applications representing the application data stored in RAM 605 while computing device 601 is on and corresponding software applications (e.g., software tasks) are running on computing device 601.

Example software (e.g., whether 617, 619, 621, or software stored in RAM) may include routines for performing processes 300, 400, 500, or 600, of for implementing all or parts of the systems illustrated in FIG. 2 (e.g., 202, 210, 220, 228, 240, 246, 252, etc.).

The functionality of the software may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to implement one or more aspects of the disclosure more effectively, and such data structures are contemplated to be within the scope of computer-executable instructions and computer-usable data described herein.

Communications module 609 may include a microphone, keypad, touch screen, and/or stylus through which a user of computing device 601 may provide input. It may also include one or more speakers for audio output and a video display device for textual, audiovisual, and/or graphical output. Computing system environment 600 may also include optical scanners (not shown).

Computing device 601 may operate in a networked environment supporting connections to one or more remote computing devices, such as 641 and 651. Computing devices 641 and 651 may be personal computing devices or servers that include any or all of the elements described above relative to computing device 601.

The network connections depicted in FIG. 6 may include Local Area Network (LAN) 625 and Wide Area Network (WAN) 629, as well as other networks. When used in a LAN networking environment, computing device 601 may be connected to LAN 625 through a network interface or adapter in communications module 609. When used in a WAN networking environment, computing device 601 may include a modem in communications module 609 or other means for establishing communications over WAN 629, such as network 631 (e.g., public network, private network, Internet, intranet, and the like). The network connections shown are illustrative, and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP), and the like may be used, and the system can be operated in a client-server configuration to permit a user to retrieve web pages from a web-based server.

Computing system environment 600 may further include a quantum co-processor 613 (e.g., a quantum computer) communicatively coupled to computing device 601 via a data bus 611. Quantum co-processor 613 may use the principles of quantum mechanics (e.g., quantum superposition, quantum entanglement, quantum interference) that include a quantum bit (qubit) generator 623 to generate qubits in a superposition state, a quantum circuit 625 for manipulating and processing qubits, and a classical-quantum interface 627 for controlling the qubit generator 623 and quantum 625 based on classical data received by bus 611, and for measuring and converting the qubits into classical data that is output to bus 611. Quantum co-processor 613 may implement qubits using a number of approaches, including utilizing superconducting materials, photonics, neutral atoms, trapped ions, quantum dots, helium electrons, NV diamonds, etc. Quantum co-processor 613 may comprise a number of devices, including super-cooled electrical circuits, lasers, electric and magnetic field generators, etc. for controlling the qubits. Quantum co-processor may receive instructions and classical input data from computing device 601, generate qubits based on the classical data and generate quantum circuits based on the instructions to initialize, manipulate, and measure the qubits, convert the measured qubits to classical output data, and return the classical output data back to the computing device 601.

While a single computing device 601 and single quantum co-processor 613 are illustrated, computing system environment 600 may include multiple computing devices 601 and/or multiple quantum co-processors 613 communicatively coupled through multiple buses 611.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smartphones, multiprocessor systems, microprocessor-based systems, set-top boxes, programmable consumer electronics, network PCs, minicomputers, mainframe computers, distributed computing environments that include any of the above systems or devices, and the like that are configured to perform the functions described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events described herein may be transferred between a source and a destination in light or electromagnetic waves traveling through signal-conducting media such as metal wires, optical fibers, or wireless transmission media (e.g., air or space). In general, one or more computer-readable media may be and/or include one or more non-transitory computer-readable media.

As described herein, the various processes and acts may be operative across one or more computing servers and one or more networks. The functionality may be distributed in any manner or may be located in a single computing device (e.g., a server, a client computer, and the like). For example, in alternative embodiments, one or more of the computing platforms discussed above may be combined into a single computing platform, and the single computing platform may perform the various functions of each computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

Artificial Intelligence (AI) refers to AI techniques that learn from training data and generate new content, such as text, code, images, and audio. AI systems, often powered by large language models (LLMs) like GPT-3, GPT-4, Meta LLaMA, and others, can be deployed through APIs, search engines, or chatbots. These models, which may be proprietary or open source, leverage deep learning processes and are generally governed by enterprise policies regarding AI and risk. Models such as BERT, T5, AlphaFold, Watson, Megatron, and others play a role in generating or interpreting language and content for various applications.

AI and LLMs are utilized throughout this disclosure for tasks including natural language processing, data processing, real-time processing, software development, and creative content generation. Specific functions include trend processing, data classification, sentiment processing, writing assistance, language translation, and decision-making support. These models enable capabilities like feedback learning, context determination, and comprehensive search operations, improving performance through iterative learning and feedback from human or system interactions. The wide range of applications supported by generative AI makes these systems a powerful tool in generating, analyzing, and managing information across diverse fields. All configurations and uses of these models are within the scope of this disclosure.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A quantum-based system for optimizing domains in a distributed network, wherein the quantum-based system comprises one or more classical computers, one or more quantum computers and at least one memory that stores computer-executable instructions, wherein the computer-executable instructions, when executed by the one or more classical computers and the one or more quantum computers, cause the quantum-based system to:
receive in real-time a plurality of characteristics of a plurality of domains, wherein each of the plurality of domains has multiple processes performed by a plurality of computer nodes in the distributed network;
initialize, based on the plurality of characteristics, quantum bits to superposition states that represent configurations of the plurality of domains;
define, based on the plurality of characteristics, a cost function that quantifies distances between the plurality of domains;
construct a quantum gradient descent circuit for the cost function;
iteratively apply the quantum gradient descent circuit to the quantum bits to minimize the cost function;
observe the quantum bits after the quantum gradient descent circuit has been iteratively applied; and
determine optimizations to the plurality of domains based on the observed quantum bits.

2. The quantum-based system of claim 1, wherein the distances indicate a degree of relatedness between performance metrics of each of the plurality of domains.

3. The quantum-based system of claim 1, wherein at least one of the distances indicates an inverse relationship such that when one metric increases, a related metric decreases.

4. The quantum-based system of claim 1, wherein the quantum gradient descent circuit is implemented with superconducting materials, photonics, neutral atoms, trapped ions, quantum dots, helium electrons or nitrogen-vacancy diamonds.

5. The quantum-based system of claim 1, wherein performance metrics of one of the plurality of domains have interdependencies with performance metrics of another one of the plurality of domains

6. The quantum-based system of claim 1, wherein the computer-executable instructions, when executed by the one or more classical computers and the one or more quantum computers, cause the quantum-based system to:
identify data in real-time from the plurality of domains;
extract, from the data, a plurality of feature sets that characterize the plurality of domains, respectively;
encode the plurality of feature sets respectively to a plurality of quantum feature data sets;
use the plurality of quantum feature data sets to respectively train and maintain a plurality of local machine learning models distributed across the plurality of domains; and
aggregate the plurality of characteristics from quantum parameters of the plurality of local machine learning model.

7. The quantum-based system of claim 6, wherein the plurality of local machine learning models comprises a quantum support vector machine or a quantum neural network implemented with quantum bits.

8. The quantum-based system of claim 6, wherein the computer-executable instructions, when executed by the one or more classical computers and the one or more quantum computers, cause the quantum-based system to:
respectively train the plurality of local machine learning models, utilizing one of a variational quantum eigen solver, a quantum approximate optimization algorithm, or a hybrid quantum-classical algorithm.

9. The quantum-based system of claim 1, wherein the computer-executable instructions, when executed by the one or more classical computers and the one or more quantum computers, cause the quantum-based system to:
transfer the plurality of characteristics between the plurality of domains with quantum cryptography.

10. The quantum-based system of claim 9, wherein the computer-executable instructions, when executed by the one or more classical computers and the one or more quantum computers, cause the quantum-based system to:
dynamically select the plurality of characteristics to encrypt based on sensitivity information represented by the plurality of characteristics.

11. A quantum-based method implemented with one or more classical computers and one or more quantum computers in a distributed network, the method comprising:
receiving in real-time a plurality of characteristics of a plurality of domains, wherein each of the plurality of domains has multiple processes performed by a plurality of computer nodes in the distributed network;
initializing, based on the plurality of characteristics, quantum bits to superposition states that represent configurations of the plurality of domains;
defining, based on the plurality of characteristics, a cost function that quantifies distances between the plurality of domains;
constructing a quantum gradient descent circuit for the cost function;
iteratively applying the quantum gradient descent circuit to the quantum bits to minimize the cost function;
observing the quantum bits after the quantum gradient descent circuit has been iteratively applied; and
determining optimizations to the plurality of domains based on the observed quantum bits.

12. The method of claim 11, wherein the distances indicate a degree of relatedness between performance metrics of each of the plurality of domains.

13. The method of claim 11, wherein at least one of the distances indicates an inverse relationship such that when one metric increases, a related metric decreases.

14. The method of claim 11, wherein the quantum gradient descent circuit is implemented with superconducting materials, photonics, neutral atoms, trapped ions, quantum dots, helium electrons or nitrogen-vacancy diamonds.

15. The method of claim 11, wherein performance metrics of one of the plurality of domains have interdependencies with performance metrics of another one of the plurality of domains

16. The method of claim 11, further comprising:
identifying data in real-time from the plurality of domains;
extracting, from the data, a plurality of feature sets that characterize the plurality of domains, respectively;
encoding the plurality of feature sets respectively to a plurality of quantum feature data sets;
using the plurality of quantum feature data sets to respectively train and maintain a plurality of local machine learning models distributed across the plurality of domains; and
aggregating the plurality of characteristics from quantum parameters of the plurality of local machine learning model.

17. The method of claim 16, wherein the plurality of local machine learning models comprises a quantum support vector machine or a quantum neural network implemented with quantum bits.

18. The method of claim 16, further comprising, to respectively train the plurality of local machine learning models, utilizing one of a variational quantum eigen solver, a quantum approximate optimization algorithm, or a hybrid quantum-classical algorithm.

19. A quantum-based system for optimizing domains in a distributed network, wherein the quantum-based system comprises a plurality of subsystems implemented with at least one classical computer, at least one quantum computer and at least one memory that stores computer-executable instructions, wherein the plurality of subsystems include a source domain system, a quantum federated learning system, a quantum gradient descent landscape navigator system, and a decision determination system, and wherein the computer-executable instructions, when executed by the at least one classical computer and the at least one quantum computer, cause:
the source domain system to:
identify data in real-time from a plurality of domains in the distributed network, and
extract, from the data, a plurality of feature sets that characterize the plurality of domains, respectively;
the quantum federated learning system to:
encode the plurality of feature sets respectively to a plurality of quantum feature data sets,
use the plurality of quantum feature data sets to respectively train and maintain a plurality of local machine learning models distributed across the plurality of domains, and
aggregate quantum parameters of the plurality of local machine learning models;
the quantum gradient descent landscape navigator system to:
initialize quantum bits to superposition states representing configurations of the plurality of domains in a global quantum model based on the aggregated quantum parameters of the plurality of local machine learning models,
define a cost function that quantifies distances between domains within the distributed network;
construct a quantum gradient descent circuit for the cost function;
iteratively apply the quantum gradient descent circuit to the quantum bits to identify a minimum of the cost function;
observe the quantum bits after the quantum gradient descent circuit has been iteratively applied; and
determine optimizations to the plurality of domains based on the observed quantum bits; and
the decision determination system to:
assign priorities of the optimizations, and
based on the determined optimizations and the priorities, use a predictive artificial intelligence model to generate an optimization process for the plurality of domains.

20. The quantum-based system of claim 1, wherein the distances indicate a degree of relatedness between performance metrics of each of the plurality of domains.
